(19) United States
(12) Patent Application Publication
(10) Pub. No.: US 2015/0221108 A1
(43) Pub. Date: Aug. 6, 2015

(54) COLOR CODED REPORT OF THEROMOGRAPH RESULTS

(71) Applicant: Daniel Beilin, Aptos, CA (US)

(72) Inventor: Daniel Beilin, Aptos, CA (US)

(21) Appl. No.: 14/174,841

(22) Filed: Feb. 6, 2014

(51) Int. Cl. G06T 11/20; G06T 11/60; G06T 11/00

(52) U.S. Cl. CPC G06T 11/206; G06T 11/001; G06T 11/60; G06T 2210/41

(57) ABSTRACT

Disclosed herein is a reporting structure and style for presenting data recorded in thermograms. Raw data recorded in the course of a thermogram consists of two sets of numbers. This data, by itself, is difficult to process quickly and arrive at conclusions. If the data is presented in categorized by color of graphical pattern, it is more readily processed. The color-coded data may further by overlaid on top of a body image for additional ease of information processing.

### INCORPORATION BY REFERENCE

U.S. patent application Ser. No. 12/028,743 entitled, “Whole Body Infrared Thermography Systems and Methods” is incorporated by reference in its entirety and for all purposes to the same extent as if the patent application was specifically and reprinted here. Co-pending and similarly filed application by the inventor of the same name, “Method for Diagnosing Selected Conditions Using Thermography” with attorney docket number BEIN1992 is also incorporated by reference herein for all purposes.

### FIELD OF THE INVENTION

The present invention relates to the field of thermographic diagnosis. The present invention, more particularly, relates to reporting data collected by a thermography device in an efficient manner.

### BACKGROUND OF THE INVENTION

Thermography is used for measuring the amount of body heat delivered to the skin from a combination of a person's cellular metabolism and their nervous system in targeted areas of the body. These measurements may be taken from a number of sites on the body. Each site projects body heat for particular internal organs. The amount of heat projected represents the condition of that organ. When conducting thermographic diagnosis, an operator will take a first measurement of temperature data at selected sites then subject the patient to some stimulus. After the stimulus, temperature data is from the selected sites is taken a second time. Comparison of the first and second measurements at selected sites reveals the reaction of various organs to stimulus. That reaction is determinative to the diagnosis of various conditions.

Presently, many conditions which can be diagnosed by this method are well known and have been conducted by professionals regularly. These known conditions include heavy metal toxicity, cranial structural imbalance, hypothyroid conditions, sinus blockage, auxiliary lymph issues, food intolerance, and many more. Thermographic diagnosis is generally very non-invasive, cheap, and can be accomplished in a relatively short period of time. Therefore, using a thermograph to diagnose conditions is preferable when possible.

When a primary factor in the use of a method is time, improving efficiency is a worthy goal. Presently data collected from thermographs is printed in either black and white or two-tone. Reading such reports is time consuming.

Accordingly, there is a need to create reports of data collected by thermographs which is more efficiently read.

### SUMMARY OF THE INVENTION

According to a first aspect of the system of the present invention, a report generated from a set of data collected by a thermography device is presented using color coding for ease of reading. The data is categorized in a handful of ways, each of which is given a color code. The color code allows one reading the report to quickly scan it and make various determinations at a glance.

The color coding in accordance with this invention is employed in a number of ways. Raw data from a thermogram consists purely of two sets of temperatures. These temperatures have to be analyzed in order to achieve any meaningful result. Since a limited number of preliminary conclusions may be drawn from comparing the two sets of temperatures, these conclusions can be rendered in a report by color. Such conclusions include that a certain site on the body is normal, hypo-regulating, hyper-regulating, blocked, or a paradox. Each of these conclusions is assigned a color. Once colors are assigned and data presented in a graphical format, a user is presented with a greater amount of information in an easily digestible manner.

According to a second aspect of the present invention, the color coded data could be overlaid on a depiction of the human body to highlight issues located to particular regions of the body.

According to a third aspect of the present invention, colors aren't used to code thermogram data. Rather, a pattern is created and achieves the same result as a color.

### BRIEF DESCRIPTION OF THE DRAWING

The patent or application file contains at least one drawing executed in color. Copies of this patent or patent application publication with color drawing(s) will be provided by the Office upon request and payment of the necessary fee. For a further understanding of the objects and advantages of the present invention, reference should be had to the following detailed description, taken in conjunction with the accompanying drawing, in which like parts are given like reference numerals and wherein:

FIG. 1 is a preferred embodiment of a thermogram report using color coding.

FIG. 2 is a graphical depiction of a human female torso with color-coded thermogram data overlaid using gradients.

FIG. 3 is a graphical depiction of a human face with color-coded thermogram data overlaid using gradients.

FIG. 4 is a graphical depiction of a human neck with color-coded thermogram data overlaid using gradients.

FIG. 5 is a graphical depiction of a human female breast with color-coded thermogram data overlaid using gradients.

FIG. 6 is a graphical depiction of a human back with color-coded thermogram data overlaid using gradients.

FIG. 7 is a graphical depiction of a set of teeth with pattern-coded thermogram data overlaid.

### DETAILED DESCRIPTION OF THE INVENTION

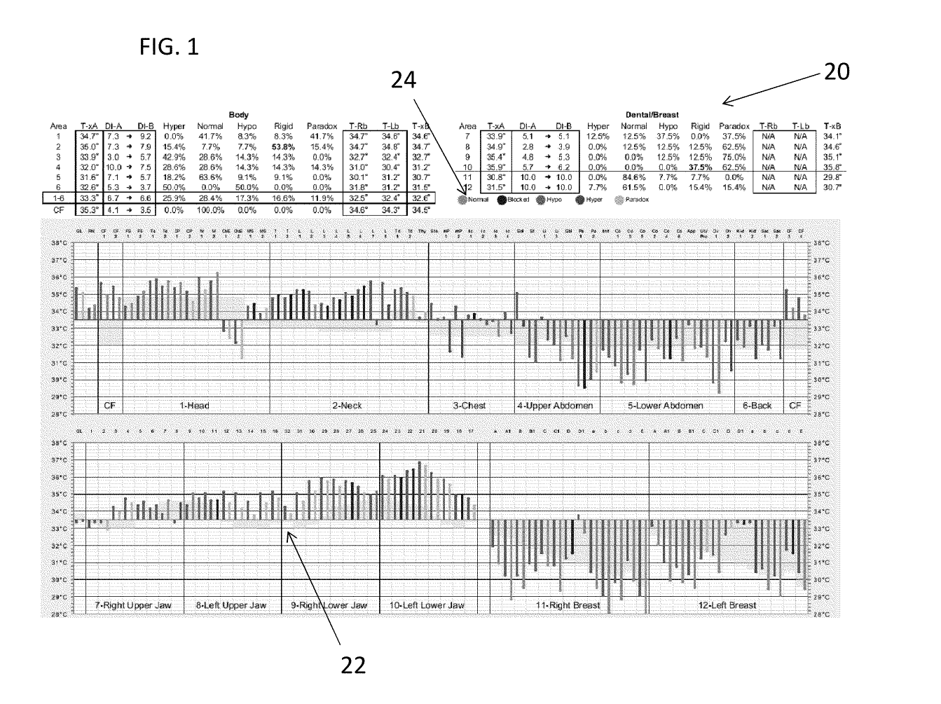

The invention will now be described in detail. Referring particular to FIG. 1, there is illustrated an exemplary embodiment of a thermogram report using color coding. The thermogram report 20, displays raw data. The raw data displayed in FIG. 1 consists of two sets of temperature data from a plurality of sites on the human body. According to the method of administering a thermogram, each site is measured twice as disclosed in U.S. patent application Ser. No. 12/028,743, and co-pending application Atty. Dock. No. BEIN1992. That data is then rendered in a report. The data can be displayed in multiple ways, though in FIG. 1 the data is displayed as a bar graph 22. The bar graph 22 is color-coded, the color-coding explained by a legend 24. The legend 24 covers multiple preliminary conclusions. These conclusions are classifications of the data based on how the data relates to itself from a first set to a second set.

The report is the rendered such that the first set of data collected is portrayed as one color (dark green in FIG. 1), and the second set of data appears in one of five colors depending on how the second set of data relates to the first. The legend 24 shows that normal results are displayed in light blue, blocked results are displayed in dark purple, hypo-regulating results are displayed in pink, hyper-regulating results are displayed in a dark blue, and paradoxical results are displayed in yellow. The actual colors used do not have to be as pictured in FIG. 1, however each color should be distinct and results that are particularly worrisome for the patient should be displayed in colors that immediately draw the attention of the technician reading the report.

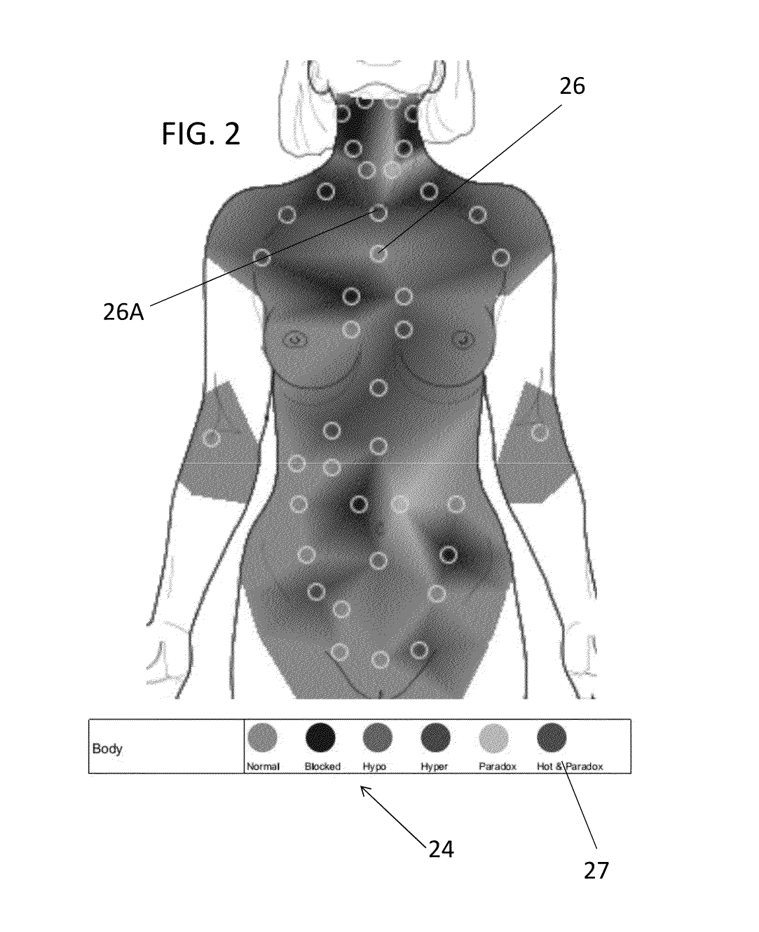

Referring particular to FIG. 2, there is illustrated a graphical depiction of a human female torso with color-coded thermogram data overlaid using gradients. The graphical depiction of the female torso contains circles which indicate relevant body sites 26. Each of these body sites 26 indicate a location where data from a thermogram was taken. After the raw data is collected, and each site is assigned a classification color associated with that classification according to the legend 24 is overlaid on top of the body site 26. Each color will fade from one body site 26 into the color associated to neighboring sites 26A. The fading gradient use of color allows a trained technician to instantly identify problems areas in the patient and quickly arrive at decisions for follow up diagnosis and treatment.

FIG. 2 additionally shows a sixth color in use. The sub category “hot and paradox” 27 is used in FIG. 2 to provide further analysis of the raw data. The exact number of categories is not limited to the five from FIG. 1 or the six in FIG. 2, but rather any distinction that is useful in the art which can be made of the raw data.

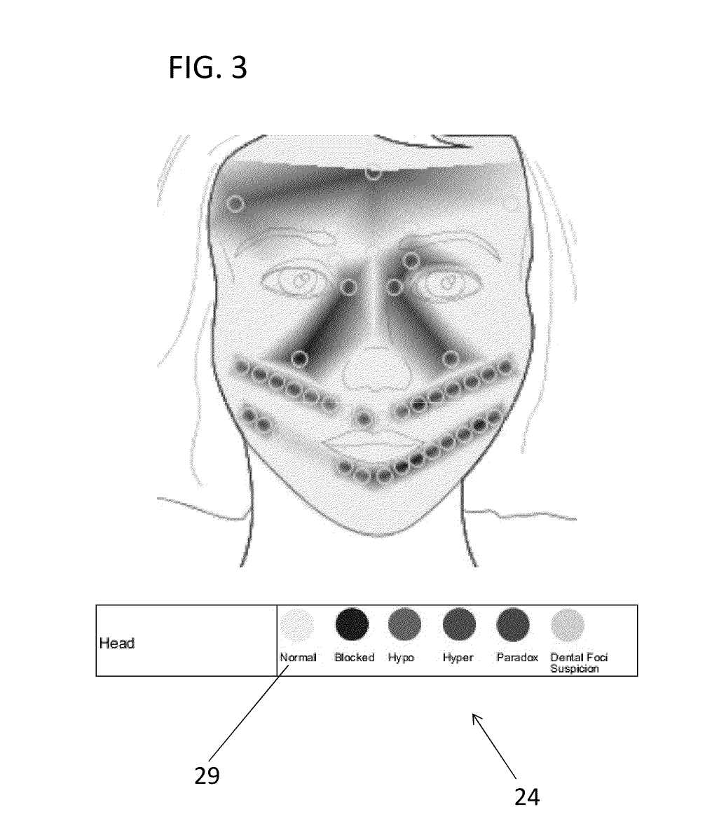

Referring particular to FIG. 3, there is illustrated a graphical depiction of a human face with color-coded thermogram data overlaid using gradients. The legend 24 of FIG. 3 shows six classifications, and it is important to note that the color choice for “normal” 29 in FIG. 3 is a tan off-white color rather than the previous light blue. The important element of the color choice in this regard is that the color draws less attention to the viewer than the other classifications which have also been reassigned different colors that do draw the attention of the viewer.

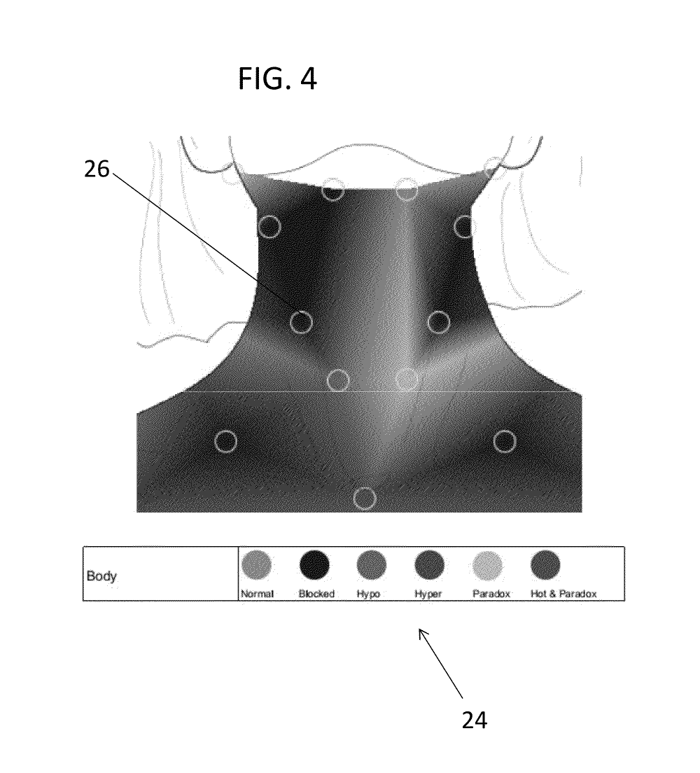

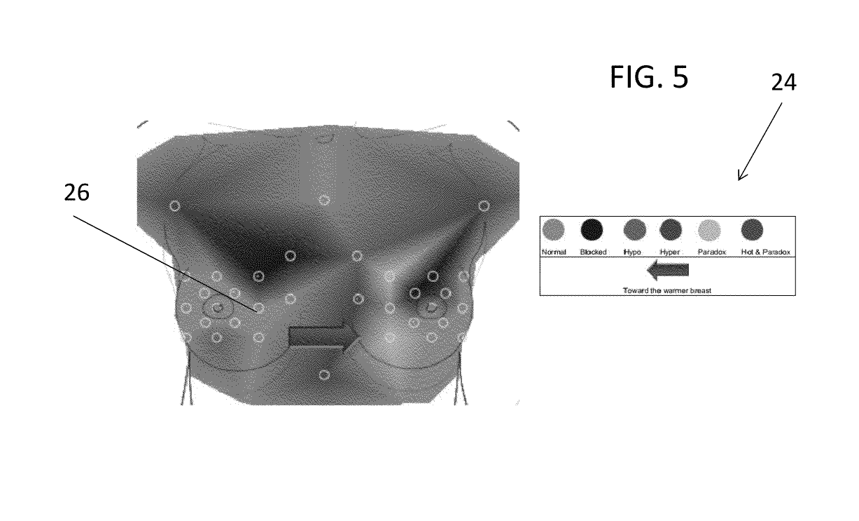

Referring particular to FIGS. 4 & 5, there is illustrated a graphical depiction of a human neck with color-coded thermogram data overlaid using gradients and FIG. 5 is a graphical depiction of a human female breast with color-coded thermogram data overlaid using gradients. Here, both sections are shown blown up compared to the torso picture of FIG. 2. Because of the great number of body sites 26 from which raw data is gathered, it makes sense to have multiple views and perspectives of the human body. It would be difficult to identify problems over the course of the full number of body sites 26 in a single picture.

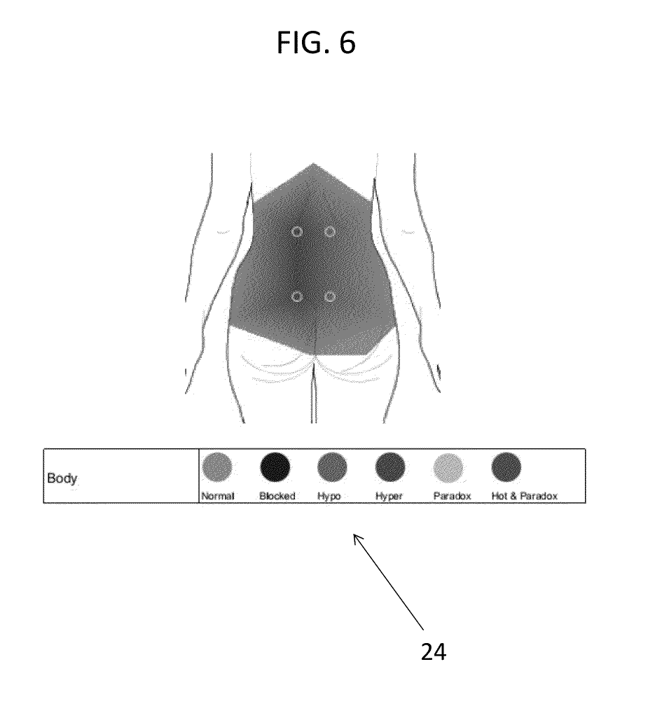

Referring particular to FIG. 6, there is illustrated a graphical depiction of a human back with color-coded thermogram data overlaid using gradients. The back is another location which can be portrayed differently and separately than the torso.

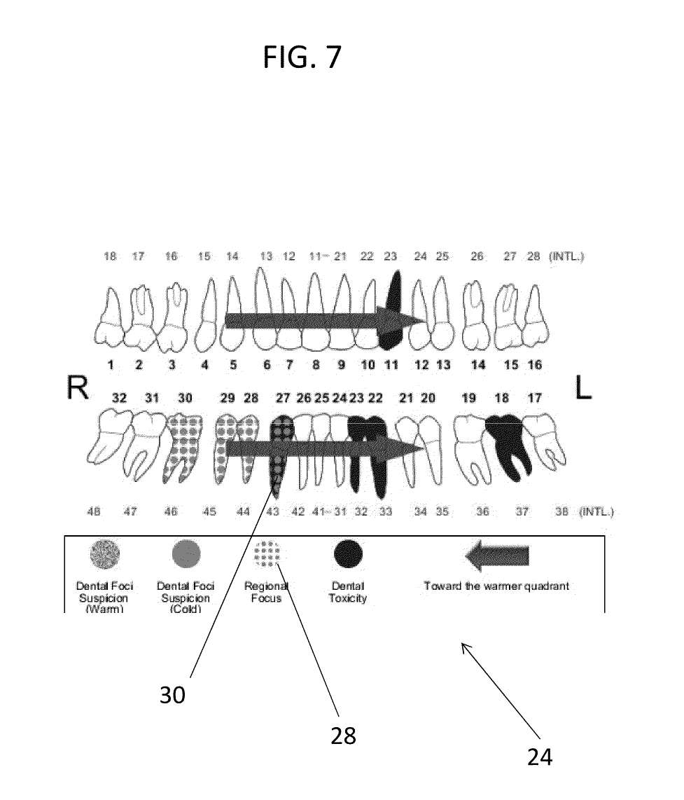

Referring particular to FIG. 7, there is illustrated a graphical depiction of a set of teeth with pattern-coded thermogram data overlaid. Instead of, or in addition to color-coding, a legend 24 can have pattern coding 28. This is especially effective when a given body site 26 may be classified multiple ways such as highlighted tooth 30.

While the foregoing detailed description has described several exemplary embodiments of the invention, it is understood that the above description is illustrative only and not limiting of the disclosed invention. Thus, the invention is to be limited only by the claims as set forth below.

What is claimed is:

1. A report comprising:
data obtained from a thermogram represented in a graphical format, the data including a first set of body temperature readings and a second set of body temperature readings; and
categories, the categories determined by the relation of the first set of body temperature readings to the second set of body temperature readings, wherein each categories is given a color code.

2. The report of claim 1 wherein, the categories include: normal, blocked, hypo-regulation, hyper-regulation, and paradox such that each category is associated with an individual color code.

3. The report of claim 2 wherein, the individual color code associated with each category is overlaid as a gradient on a graphical depiction of the human body.

4. The report of claim 3 wherein the graphical depiction of the human body is of the torso.

5. The report of claim 3 wherein the graphical depiction of the human body is of the neck.

6. The report of claim 3 wherein the graphical depiction of the human body is of the head.

7. The report of claim 3 wherein the graphical depiction of the human body is of the teeth.

8. The report of claim 3 wherein the graphical depiction of the human body is of the back.

9. The report of claim 3 wherein the graphical depiction of the human body is of the breasts.

10. The report of claim 2, wherein the category for paradox additionally comprises a sub category for: hot and paradox.

11. A report comprising:
data obtained from a thermogram represented in a graphical format, the data including a first set of body temperature readings and a second set of body temperature readings; and
categories, the categories determined by the relation of the first set of body temperature readings to the second set of body temperature readings, wherein each categories is given a graphical pattern code.
